(19) United States
(12) Patent Application Publication
(10) Pub. No.: US 2025/0012464 A1
(43) Pub. Date: Jan. 9, 2025

(54) METHOD AND SYSTEM FOR PREDICTIVE MAINTENANCE OF AN ULTRASONIC SENSOR FOR HVAC SYSTEMS

(71) Applicant: BELIMO HOLDING AG, Hinwil (CH)

(72) Inventors: Patrick REISSNER, Herrliberg (CH); Lucien BUCHMANN, Rapperswil (CH)

(73) Assignee: BELIMO HOLDING AG, Hinwil (CH)

(21) Appl. No.: 18/292,666

(22) PCT Filed: Jul. 11, 2022
(86) PCT No.: PCT/EP2022/069272

§ 371 Date: Jan. 26, 2024

(30) Foreign Application Priority Data
Jul. 27, 2021 (CH) 070101/2021

(51) Int. Cl. F24F 11/00; F24F 11/38; F24F 11/64; F24F 110/10; F24F 110/30; G01F 1/66

(52) U.S. Cl. CPC F24F 11/0001; F24F 11/38; F24F 11/64; G01F 1/66; F24F 2110/10; F24F 2110/30

(57) ABSTRACT

A method for predictive maintenance of an ultrasonic sensor in an HVAC system, the ultrasonic sensor including one or more ultrasonic transducers that measure ultrasonic signals as a function of time during an operation of the HVAC system, and produce raw electronic signals as a function of time, the method including the method elements of extracting a signal parameter from the raw electronic signals; creating a set of data including the signal parameter as a function of time; selecting one or more limit parameters; and estimating a time limit based on the set of data. The time limit is a time when the signal parameter is predicted to reach the limit parameter.

### FIELD OF THE INVENTION

The present invention relates to a method for predictive maintenance of an ultrasonic sensor and/or ventilation system and to a system, in particular sensor and computer program product, for performing the method. In particular, it relates to predictive maintenance of ultrasonic sensors preferably used in heating, ventilation and air conditioning (HVAC) systems.

### BACKGROUND

The use of ultrasonic sensors and ultrasonic flowmeters in an HVAC (heating, ventilation and air/conditioning) systems has grown significantly due to their many beneficial features such as high accuracy, non-intrusive nature and lack of moving parts. WO 2010/122117 discloses a system comprising ultrasonic sensors, and in particular it describes a ventilation system which draws air from an exterior of a building through a ventilation duct into an interior of the building.

The ventilation system has an ultrasonic sensor positioned in the ventilation duct upstream and/or downstream of the ventilator for measuring the volume flow or air velocity. The ultrasonic sensor of WO 2010/122117 comprises a pair of ultrasonic transceivers which are mounted in a spaced apart relationship facing each other on opposing surfaces of the ventilation duct, emitting and receiving ultrasonic waves in an angle between 60-90 degrees relative to the surface of the ventilation duct in upstream and downstream direction. In a controller, the phase difference and time-of-flight difference between the transmitted and received ultrasonic signals in upstream and downstream direction are determined and used to calculate the velocity and temperature of the air and to control these parameters by a controller that communicates with a valve to regulate the temperature and velocity of the airflow and to control the fan speed and temperature of the ventilation unit by communication through the control box on the valve.

To assure proper operation, ultrasonic sensors need regular maintenance and diagnostics. Typically, the maintenance is performed on a regular basis regardless of the state of the sensors. To assure that ultrasonic sensors are still in acceptable state, the maintenance is performed well in advance based on the standard prediction value which is based on the sensor specifications. This kind of maintenance produces additional costs and time delays since the maintenance is performed more often than needed.

Maintenance of ultrasonic sensors is not the only problem to be solved. Rather, the ultrasonic sensors still continue functioning with rather large amounts of dust deposited thereon. However, dust or other debris can accumulate in the ventilation system and ventilation ducts, which can become a hygenic problem and a fire safety issue. Therefore, duct cleaning is recommended typically on a fixed time basis, such as every few years. However, real contamination is very dependent on the usage of the room or building which is ventilated by the ventilation or HVAC system.

For above mentioned reasons, there is still a need for new and improved methods and systems for predictive maintenance and diagnostics of ultrasonic sensors and ventilation systems as a whole.

### SUMMARY

Therefore, it is an object of the present disclosure to propose a method and system for predictive maintenance of an ultrasonic sensor configured to be used in a ventilation system, in particular HVAC systems, and/or for predictive maintenance of the ventilation system, in particular HVAC system, comprising the ultrasonic sensor.

According to the present disclosure, this object is achieved by the features of the independent claims. Moreover, further advantageous embodiments emerge from the dependent claims and claim combinations, the description and drawings.

A method for predictive maintenance of a system for ventilation, in particular ventilation system or HVAC (heating, ventilation, and air-conditioning) system, comprising an ultrasonic sensor and/or for predictive maintenance of an ultrasonic flowmeter assembly comprising the ultrasonic sensor configured to be used in the system for ventilation or ventilation system, is proposed. The ultrasonic sensor comprises: at least one ultrasonic transducer configured to measure ultrasonic signals as a function of time during an operation of the HVAC system and to produce raw electronic signals as a function of time. The method comprises the method elements of: (a) deriving a signal parameter based on the raw electronic signals; (b) creating a set of data comprising the signal parameter as a function of time; selecting at least one limit parameter; and estimating a time limit based on the set of data, wherein the time limit is a time when the signal parameter is predicted to reach the limit parameter.

In embodiments, in step (a) the deriving the signal parameter comprises extracting the signal parameter from the raw electronic signals or from electronic signals processed therefrom, in particular amplified and/or filtered electronic signals.

The following embodiments include modifications, improvements and/or variations of the method for predictive maintenance of the or ventilation system and/or ultrasonic flowmeter assembly, in particular ultrasonic sensor.

In an embodiment, the ultrasonic signal is emitted by the ultrasonic transducer and/or by a second ultrasonic transducer, and the ultrasonic signals are reflected at least once before being measured by the ultrasonic transducer.

In an embodiment, the ultrasonic signals are transferred via at least two different reflection paths. In a variation of this embodiment, the steps of the method (a)-(d) are performed separately for each of the reflection paths.

In an embodiment, the signal parameter is an amplitude of the raw electronic signal.

In an embodiment, the method comprises the step of amplifying the raw electronic signals by applying a gain factor to produce amplified electronic signals as a function of time, wherein the gain factors are adapted to provide an amplification of the raw electronic signals such that the amplified electronic signals exceed a given minimum threshold value, and wherein the signal parameter is or corresponds to the gain factor and the limit parameter is or corresponds to a gain factor limit.

In an embodiment, the sensor comprises a signal processing unit, in particular processor, configured to process, e.g. filter the raw electronic signals and/or to amplify the raw electronic signals by applying the gain factor to produce the amplified electronic signals as a function of time.

In an embodiment, the limit parameter is determined such that a required e.g. predetermined minimum signal to noise ratio of the raw electronic signal is not underrun; and/or wherein the gain factor limit is determined such that a required e.g. predetermined minimum signal to noise ratio of the amplified electronic signal is not underrun.

In an embodiment, the method is further comprising in step (b) a step of selecting an initial signal parameter corresponding to a specified or a predetermined value of the raw electronic signal. Alternatively, or in addition, the method may comprise in step (b) a step of selecting an initial gain factor corresponding to a specified or a predetermined value of the amplified electronic signal.

In an embodiment, the initial signal parameter and/or the initial gain factor is or are determined during a calibration or start-up procedure; and/or the set of data comprises at least two data pairs.

In an embodiment, the method comprises a step of creating a signal parameter time curve using the set of data. In a variation of this embodiment, the signal parameter time curve is obtained by a step of interpolating the set of data.

In an embodiment, the method comprises a step of extrapolating the signal parameter time curve and determining the time limit from an intersection between the extrapolated signal parameter time curve and a limit parameter threshold value or usually constant threshold curve. In another embodiment, the extrapolation is based on a subset of the set of data.

In an embodiment, the extrapolation is performed on a part of the signal parameter time curve bounded by a lower calculation limit and an upper calculation limit of the signal parameter.

In an embodiment, the step of interpolating is performed repeatedly or stepwise when the signal parameter reaches a subsequent lower or a subsequent upper calculation limit.

In an embodiments, a series of calculation limits is selected such that a distance between subsequent calculation limits is monotonously decreasing, in particular when approaching the limit parameter and/or an alarm threshold.

In an embodiment, the signal parameter time curve and/or the interpolation and/or the extrapolation is linear or stepwise linear or non-linear.

In embodiments, measurement time intervals are selected to be in a range from one month to several years.

In an embodiment, at least one of the raw electronic signals is obtained as an average over a plurality of measurements, or at least one of the raw electronic signals is obtained by signal processing, in particular in the signal processing unit.

In an embodiment, the method is further comprising a step of raising an alarm when the signal parameter reaches the limit parameter.

In an embodiment, the method further comprises the step of setting an alarm threshold for the signal parameter smaller or larger than the limit parameter and raising an alarm when the signal parameter reaches the alarm threshold.

In further embodiments, the limit parameter and/or the alarm threshold is determined such that a threshold amplitude of the raw electronic signals, which is indicative of a maximal allowable dirt accumulation in the system for ventilation, is not underrun; and/or wherein the gain factor limit and/or the alarm threshold is determined such that a threshold amplitude of the amplified electronic signals, which is indicative of a maximal allowable dirt accumulation in the system of ventilation, is not underrun. Herein, dirt may comprise dust, debris, or contamination of any kind, which can degrade the performance of the ultrasonic sensor.

In embodiments thereof, the maximal allowable dirt accumulation in the system for ventilation corresponds to a corresponding (e.g. predetermined) dirt accumulation on the ultrasonic transducer(s) and/or on reflection points or surfaces of the conduit, which causes a detectable reduction in amplitude of the raw electronic signals until these reach their threshold amplitude. Alternatively or in addition, the maximal allowable dirt accumulation in the system for ventilation corresponds to a corresponding (e.g. predetermined) dirt accumulation on the ultrasonic transducer(s) and/or on reflection points or surfaces of the conduit, which causes an increase in gain factors used for providing the amplified electronic signals until the gain factors reach their threshold amplitude.

For example, the maximal allowable dirt accumulation in the system of ventilation may be chosen according to hygenic requirements or recommendations. Thus, the maximal allowable dirt accumulation may be a hygenic maximal allowable dirt accumulation, and the limit parameter may be a hygenic limit parameter and/or the alarm threshold may be a hygenic alarm threshold.

Alternatively or in addition, the maximal allowable dirt accumulation in the system of ventilation may be chosen according to fire safety requirements or recommendations. Thus, the maximal allowable dirt accumulation may be a fire safety maximal allowable dirt accumulation, and the limit parameter may be a fire safety limit parameter and/or the alarm threshold may be a fire safety alarm threshold.

The advantage of such hygenic or fire safety limit parameter or alarm threshold is that an even earlier motivation for cleaning the ventilation system, in particular the ventilation ducts and/or ultrasonic transducer(s), is given. This allows for optimal system maintenance.

Alternatively or in addition, the limit parameter is a sensor maintenance limit parameter and/or the alarm threshold is a sensor maintenance alarm threshold. This has the advantage that cleaning of the ultrasonic transducers and/or the ventilation system, in particular the ventilation ducts, can be postponed to an instant in time when malfunctioning of the ultrasonic sensor would start. This allows for optimal sensor maintenance.

In an embodiment, the sensor is an ultrasonic sensor for measuring a flow and/or temperature of a fluid through a channel.

In an embodiment, the method serves for detecting malfunctioning of the ultrasonic sensor, in particular signal fading due to accumulation of dust or debris on at least one of the ultrasonic transducer(s) and/or on at least one reflection point or reflection surface of the conduit.

In an embodiment, the ultrasonic signals from ultrasonic transducers providing reduced raw electronic signals or requiring increased gain factors compared to other ultrasonic transducers are used with less weight or are neglected, e.g. when determining the flow and/or temperature of the fluid through the channel.

In one embodiment, the sensor comprises at least two ultrasonic transducers that are fixed to a channel section and are arranged at a distance from each other along the channel section, in particular wherein the channel section comprises at least one reflector for providing a reflection path for one or between two of the ultrasonic transducers.

A further aspect of the invention is related to a computer program product comprising instructions which, when the program is executed by a computer, cause the computer to carry out the steps of the method as disclosed herein.

Another aspect of the invention is related to a sensor comprising: an ultrasonic transducer configured to measure ultrasonic signals as a function of time and to produce raw electronic signals as a function of time; and a signal processing unit or processor configured to process the raw electronic signals and/or to amplify the electronic signals by applying a gain factor to produce amplified electronic signals as a function of time, wherein the sensor is configured to perform the method for predictive maintenance disclosed herein.

### BRIEF DESCRIPTION OF THE DRAWINGS

The present invention will be explained in more detail, by way of non-limiting examples, with reference to the schematic drawings in which:

FIG. 1a shows a schematic illustration of an ultrasonic sensor in accordance with an embodiment;

FIG. 1b shows a schematic illustration of an ultrasonic sensor in accordance with an embodiment;

FIG. 2 show an illustration of ultrasonic signal waveforms detected by the ultrasonic sensor in accordance with an embodiment;

FIG. 3 shows a schematic illustration of an ultrasonic sensor in accordance with an embodiment;

FIG. 4a shows in lateral cross-sectional view (on the left) and cross-sectional view (on the right) orthogonal to flow direction an ultrasonic flowmeter assembly designed for measuring a flow and/or temperature of a fluid through a round channel and/or for measuring a channel dimension by using an I-shaped path of ultrasonic transmission in accordance with embodiments of the invention;

FIG. 4b shows in lateral cross-sectional view (on the left) and cross-sectional view (on the right) orthogonal to flow direction an ultrasonic flowmeter assembly designed for measuring a flow and/or temperature of a fluid through a round channel by using a V-shaped path of ultrasonic transmission in accordance with embodiments of the invention;

FIG. 5 shows a schematic illustration of one example of a graph of a signal parameter as a function of measurement time in accordance with an embodiment;

FIG. 6 shows a schematic illustration of one example of a graph of an applied gain as a function of measurement time in accordance with an embodiment;

FIG. 7 shows a schematic illustration of one example of a graph of an applied gain as a function of measurement time and having a plurality of calculation limits in accordance with an embodiment.

### DETAILED DESCRIPTION

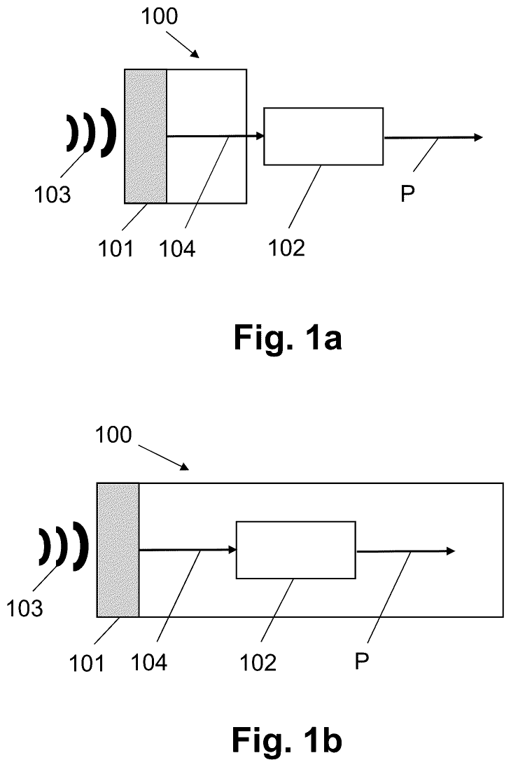

FIG. 1a shows a schematic representation of an exemplary embodiments of an ultrasonic sensor 100 preferably configured to be used in a ventilation or HVAC system. The sensor comprises a transducer 101 configured to measure ultrasonic signals 103 as a function of time during an operation of the HVAC system. In one embodiment the ultrasonic signal 103 is reflected at least once from a reflective surface before reaching the transducer 101. The reflective surface may be part of the HVAC system such as a pipe or a channel. The ultrasonic transducer 101 is configured to produce raw electronic signals 104 after receiving the ultrasonic signals 103.

Still referring to FIG. 1a, the raw electronic signals 104 may be filtered or conditioned inside or outside the ultrasonic sensor 100 either digitally or by hardware or by both. The raw electronic signals 104 are further sent to a signal processing unit 102 or processor 102, which outputs a signal parameter P based on the input raw electronic signals 104. The signal processing unit 102 may be outside the ultrasonic sensor 100 as shown in FIG. 1a, or it may be an integral part of the ultrasonic sensor 100 as shown in an embodiment in FIG. 1b. The signal processing unit 102 may be a microcontroller, an application-specific integrated circuit (ASIC) or any other appropriate device that is configured to process electronic signals 104 and to output a characteristic signal parameter P (briefly signal parameter) as disclosed herein. In particular, the signal parameter P can be extracted from the raw electronic signals 104 (FIG. 1a, 1b) or from the amplified and/or filtered electronic signal 107 (FIG. 3). For example, the signal parameter P can be an amplitude of the raw electronic signal 104 (FIG. 1a, 1b) or a gain factor g applied to obtain the amplified signal 107 (FIG. 3).

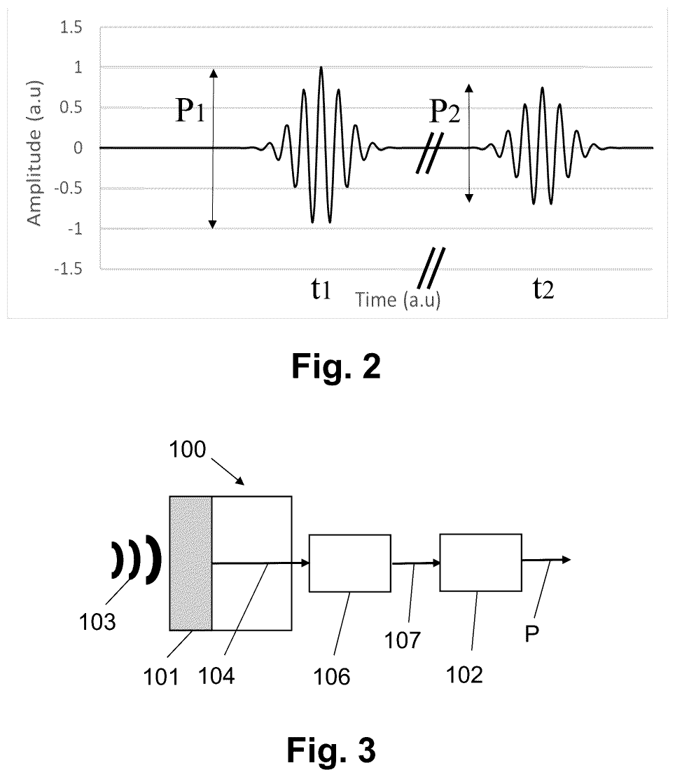

FIG. 2 shows a schematic representation of two raw electronic signals 104 received at the transducer 101 at two different instants of time, t1 and t2. The raw electronic signals 104 are shown as waveforms having a specific shape, frequency and amplitude among other characteristics. The raw electronic signal 104 may be a voltage generated by the ultrasonic transducer 101. From the signal waveforms, it is possible to extract signal parameters P, and in this particular case, the signal parameters P1 and P2 at time t1 and t2 respectively. The extraction of the signal parameter(s) may be done by the signal processing unit or processor 102. In the embodiment shown in FIG. 2, the signal parameter P is an amplitude of the waveforms, herein e.g. maximum peak-to-peak amplitude.

Depending on the different conditions, the amplitudes of the raw electronic signals 104 may change as a function of time, which causes the signal parameter P to change its value from P1 at the time t1 to P2 at the time t2. A set of data (Pi, ti) comprising the signal parameter P as a function of time may be created, stored and/or processed. For the example of FIG. 2, the set of data would be: (P1, t1), (P2, t2).

In another embodiment shown in FIG. 3, the raw electronic signal 104 is amplified by an amplifier 106 to produce an amplified electronic signal 107. The amplifier 106 may be a part of the ultrasonic sensor 100 or the signal processing unit or processor 102, or it might be a separate device. The amplifier 106 applies a gain factor g to produce the amplified electronic signals 107 as a function of time. The gain factors are adapted to provide an amplification of the raw electronic signals 104 such that the amplified electronic signals 107 exceed a given minimum threshold value. In this embodiment, the characteristic signal parameter P of the raw electronic signal 104 corresponds to the applied gain factor g. The set of data (gi, ti) may be created comprising applied gain factors as a function of time.

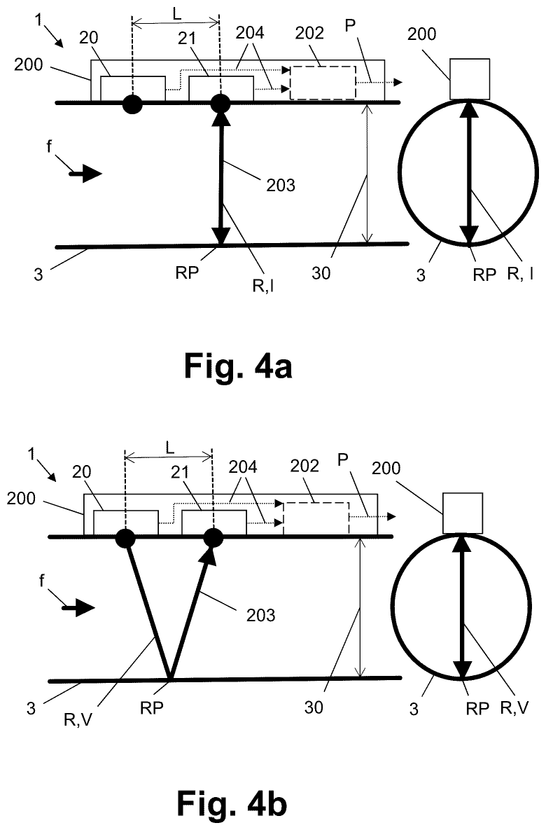

FIGS. 4a. and 4b show the embodiments in which the ultrasonic transducers 20, 21 are part of the ultrasonic sensor 200, which is a component of a flowmeter assembly 1 designed for measuring a flow and/or temperature of a fluid through a channel. The ultrasonic flowmeter assembly 1 may be preassembled and configured to be attached to the channel having a flow direction f through the channel, or the ultrasonic sensor 200 may be attached to the existing conduit 3 at a site of operation. The conduit 3 may be an integral part of a larger system such as an HVAC system, and it may have different cross section profiles such as, but not limited to, circular or rectangular. The flowmeter assembly 1 may have a plurality of the ultrasonic sensors 100, 200, and preferably two ultrasonic sensors 20 and 21 as shown in FIG. 4a and FIG. 4b.

Referring to FIG. 4a, the at least one ultrasonic transducer 20, 21 is configured to emit ultrasonic pulses into the conduit 3 and to receive ultrasonic pulses after having travelled along at least one path R in the conduit section 3 and to output measurement data in a form of the raw electronic signals 204 to the processor 202, wherein the ultrasonic transducers 20, 21 can be 101 and the signal processing unit 202 can be 102 as shown in FIG. 1a, 1b, and FIG. 3. The ultrasonic transducers 20, 21 may be operating in a range of 20 kHz to 400 kHz and preferably at 40 kHz. The ultrasonic transducers 20, 21 preferably have a broad emission characteristic (or emission angle) and/or receiving characteristic (or receiving angle) to allow measurement and assessment of a plurality of ultrasonic signal paths. The paths can be or comprise reflective paths R which include one or more reflection points RP or reflecting areas RP or reflection surfaces RP. Alternatively, or in addition, the ultrasonic signal paths can also be or comprise direct paths (not shown).

In the embodiment of FIG. 4a the reflection path R is a double pass I-shaped path, which is characterized in that the ultrasonic pulses emitted by the ultrasonic transducer 21 are reflected back to the ultrasonic transducer 21. The path R may preferably be chosen to lie in a plane orthogonal to the flow direction for a longitudinal axis of the conduit 3. In the double pass I-shaped path, the ultrasonic pulse is reflected once at a reflection point RP or a reflection area RP or a reflection surface RP.

In embodiment of FIG. 4b, the reflective path R is a V-shaped path V, which may be in both directions i.e. from the first transducer 20 to the second transducer 21 and in the opposite direction. The V-shaped path has one reflection point or area or surface RP on the conduit 3. In other words, the first V-path and the second path V-path are congruent, i.e. are identical in shape and counter-directional to one another. Differently shaped first paths and/or differently shaped second paths may also be used separately or in combination.

Various environmental and working conditions may influence the operation of the transducers 101; 20, 21 of the ultrasonic sensors 100, 200. One of the common causes for non-optimal performance or even failure of the ultrasonic sensors 100, 200 is accumulation of dirt and/or dust on the emission and/or receiving surface of the transducers 101; 20, 21. This change in the performance requires monitoring and maintenance of the ultrasonic sensors, and in addition it can be used to monitor dirt accumulation in the ventilation system, in particular in the ventilation ducts, and to predict time instances or time intervals for maintenance actions of the ventilation system, such as cleaning of ventilation ducts 3 and/or of the ultrasonic transducers 101; 20, 21.

When dust accumulates on top of the transducers or on reflection points or areas or surfaces RP of the conduit or elsewhere inside the conduit, the ultrasonic signal is damped up to a point where the gain saturates or the amplitude decreases. With further dust accumulation, the electronic signal becomes so small that the signal to noise ratio becomes too small for a reliable measurement. At this point, the ultrasonic sensor is not able to function properly, and it should be serviced and cleaned.

According to the invention, the method for predictive maintenance of an ultrasonic sensor 100, 200 configured to be used in an HVAC system comprises the following steps:
(a) deriving a signal parameter P based on the raw electronic signals 104, in particular extracting the signal parameter P from the raw electronic signals 104 or the amplified signals 107;
(b) creating a set of data (Pi, ti) comprising the signal parameter P as a function of time;
(c) selecting at least one limit parameter (PL);
(d) estimating a time limit (tL) based on the set of data (Pi, ti), wherein the time limit (tL) is a time when the signal parameter (P) is predicted to reach the limit parameter (PL).

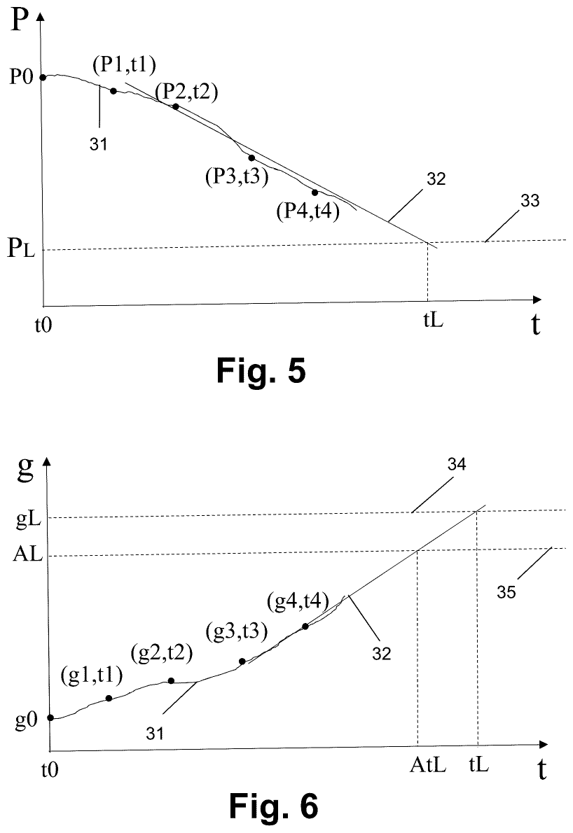

The method may be further explained referring to FIG. 5-7. FIG. 5 shows evolution of the extracted signal parameter P as a function of time. The set of data (Pi, ti) has been created and plotted in FIG. 5. An initial signal parameter Po corresponds to a specified or a predetermined value of the raw electronic signal 104, and it may be selected as a starting point of the set of data at time to. The initial signal parameter Po may be determined during a calibration or start-up procedure. While FIG. 5 shows four data pairs for illustration purpose, the set of data (Pi, ti) in general comprises at least two data pairs (P1, t1) and (P2, t2), and it may comprise hundreds or thousands or more data pairs over shorter or longer period of time, and sometimes over the range of few years. Time difference between points in the set of data may be constant or may vary in a non-regular fashion. In one preferred embodiment, the frequency of data point measurement increases with the time t.

The limit parameter PL shown in FIG. 5 may be determined such that a required (e.g. predetermined) minimum signal to noise ratio of the raw electronic signal 104 is not undershot. In one preferred embodiment, the signal parameter P is an amplitude of the electronic signal waveform. While estimating a time limit tL, when the signal parameter P is predicted to reach the limit parameter PL, may be based directly on the set of data (Pi, ti) according to the invention, the preferred embodiment comprises creation of a signal parameter time curve 31 by using the set of data (Pi, ti). The signal parameter time curve 31 may be obtained by a step of interpolating the set of data (Pi, ti). In one preferred embodiment, the interpolation is linear or stepwise linear, but other types of interpolations may also be used, e.g. non-linear interpolation.

In preferred embodiments, the signal parameter time curve 31 is further extrapolated to obtain an extrapolated signal parameter time curve 32. Determination of the time limit tL, i.e. when the signal parameter P is predicted to reach the limit parameter PL, is achieved from an intersection between the extrapolated signal parameter time curve 32 and a limit parameter threshold value PL, which can be represented by a constant limit parameter threshold curve 33 over the relevant measurement time window. When the time or time interval, when the signal parameter P is predicted to reach the limit parameter PL, has been determined, it can be output to the user for scheduling maintenance, e.g. cleaning, of the ventilation system and/or flowmeter assembly 1, in particular ultrasonic sensor 100, 200 and/or ultrasonic transducers 101; 20, 21.

FIG. 6 shows an embodiment in which the signal parameter P is an amplification gain factor g, and the limit parameter PL is a gain factor limit gL. The set of data (gi, ti) has been created and plotted in FIG. 6, and the gain time curve 31 has been obtained by a step of interpolating the set of data (gi, ti). In the preferred embodiment the gain time curve 31 is further extrapolated to obtain an extrapolated gain time curve 32. Determination of the time limit tL is achieved from an intersection between the extrapolated gain time curve 32 and a gain threshold value 34, represented by a constant threshold curve 34.

Both in FIG. 5 and FIG. 6, the interpolation and extrapolation of signal parameter time curves may be done on a subset of the set of data (Pi, ti) or (gi, ti), for example by using only points (P2, t2), (P3, t3) and (P4, t4). The decision regarding the choice of points may be predetermined or based on the decision of the operator, for example.

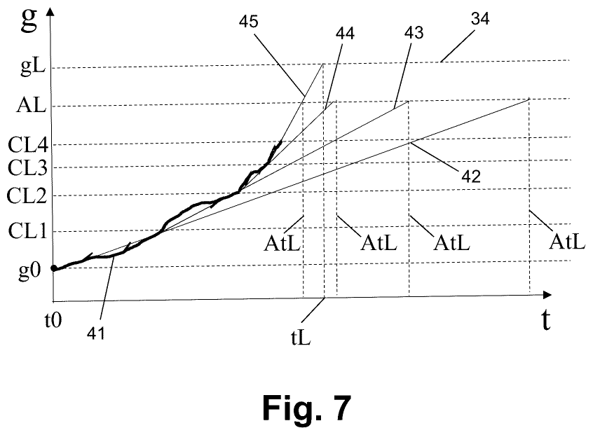

FIG. 7 shows yet another example of the evolution of the applied gain g as a function of time t. In addition to the initial gain factor curve characterized by gain factor go (i.e. constant curve through go) and in addition to the gain limit curve characterized by the gain factor limit gL (i.e. constant gain factor limit curve 34 through gL) there are several calculation limits CL1, CL2, CL3, CL4 positioned between the initial gain factor curve go and the gain factor limit curve 34. In one preferred embodiment, the extrapolation is performed on a part of the signal parameter time curve 41, here gain factor time curve 41, bounded by a lower calculation limit CL1, CL2, CL3 and an upper calculation limit CL2, CL3, CL4. In one embodiment the step of interpolating is performed repeatedly or stepwise, when the gain factor reaches a subsequent lower or a subsequent upper calculation limit CL1, CL2, CL3, CL4. As shown in FIG. 7 the same gain factor time curve 41 may have different extrapolation curves 42, 43, 44, 45 depending on the time interval of the gain factor time curve 41 on which the extrapolation is performed. Different calculation limits may be set as a function of the use of the ultrasonic sensor.

In embodiments, a series of calculation limits CL1, CL2, CL3, CL4 is selected such that a distance between subsequent calculation limits CL1, CL2; CL2, CL3; CL3, CL4 is monotonously decreasing, in particular when approaching the limit parameter PL and/or an alarm threshold AL. This has the advantage that an accelerated increase in the signal parameter time curve 41, here gain factor time curve 41, can be monitored more closely and the precision of predicting a time or time interval for maintenance, e.g. cleaning, of the ventilation system or flowmeter assembly 1 or ultrasonic sensor 100, 200 or ultrasonic transducers 101; 20, 21 can be improved.

Both FIG. 6 and FIG. 7 show an additional alarm threshold AL, which can be used to alert the user at time AtL that the ultrasonic transducer may be close to unsatisfactory sensor performance or even sensor failure before reaching the time limit tL, when intersection between the extrapolated gain time curve 42 or 43 or 44 or 45 with the gain threshold value gL represented by the curve 34 occurs. Alternatively or in addition, the additional alarm threshold AL can be used to alert the user at time AtL that the ventilation system may be close to unsatisfactory hygenic and/or fire safety conditions before reaching the time limit tL. The additional alarm threshold AL can also be present in FIG. 5 as a warning, before the limit parameter PL is reached. At the time the alarm threshold AL is reached, the user is informed when cleaning of the ultrasonic sensor 100, 200 and/or ventilation system should be scheduled.

The situation depicted in FIG. 7 may occur for example, when use of a zone inside an HVAC system changes over time. The zone may be a commercial or a residential space for example. The zone may be used as an office for a certain number of years. In this case, the accumulation of the dust on the transducers may not be significant. This is represented as a section between the first calculation limit CL1 and the second calculation limit CL2. The extrapolation curve 43 is calculated based on this period, and it shows that the alarm limit AL and the gain limit gL will be reached in a relatively late time, i.e. there is no need for a maintenance in a near future.

The situation may change, if the zone is later used e.g. as a workshop. Due to the change of environment, a rate of dust accumulation may increase significantly, which will produce steeper increase of the applied gain g as a function of time t. This is visible observing a section of the gain time curve g (t) between the second calculation limit CL2 and the third calculation limit CL3 or between the third calculation limit CL3 and the fourth calculation limit CL4. The extrapolation curves 44 or 45 are now calculated based on these periods, and it shows that the alarm limits AL and the gain limits gL will be reached relatively sooner, i.e. there may be need for the maintenance in a nearer future.

The method of diagnosing and the flowmeter assembly and ultrasonic sensor as disclosed herein have the advantage, that maintenance intervals can be optimized, reliability of flow and/or temperature measurement and control can be improved, and better control of and compliance with hygene and fire safety requirements or recommendations of the ventilation system can be achieved.

### REFERENCE SYMBOLS

1 flowmeter assembly
100, 200 ultrasonic sensor, ultrasonic flow sensor, ultrasonic temperature sensor
101, 20, 21 ultrasonic transducer
102, 202 signal processing unit, processor
103, 203 ultrasonic signal(s)
104, 204 raw electronic signal(s)
106 amplifier, filter, amplifier and filter
107 amplified signal
3 conduit section, part of channel
30 channel dimension
31, 41 signal parameter time curve
32 extrapolated curve
33 threshold value for limit parameter PL
34 threshold value for gain factor limit gL
35, AL threshold value for alarm, alarm limit
42, 43, 44, 45 extrapolation curves
CL1, CL2, CL3, CL4 calculation limits
f conduit axial direction, flow direction
g, gi gain factor(s)
gL gain factor limit
L distance between ultrasonic transducers (measured along channel extension)
P signal parameter
PL limit parameter
t time
tL time limit for limit parameter, time limit for gain factor limit
AtL time limit for alarm
R reflection path of ultrasonic signal (continuous or quasi-continuous) or ultrasonic pulses
RP reflection point, reflecting area, reflecting surface
V V-shaped path
I I-shaped path
Δ delta-shaped path, triangular path

1. A method for predictive maintenance of a system for ventilation, in particular ventilation system or HVAC system, comprising an ultrasonic sensor and/or for predictive maintenance of an ultrasonic flowmeter assembly comprising the ultrasonic sensor configured to be used in the system for ventilation, the ultrasonic sensor comprising: at least one ultrasonic transducer configured to measure ultrasonic signals as a function of time during an operation of the ventilation system and to produce raw electronic signals as a function of time, the method comprising the method elements of:
(a) deriving a signal parameter based on the raw electronic signals;
(b) creating a set of data comprising the signal parameter as a function of time;
(c) selecting at least one limit parameter;
(d) estimating a time limit based on the set of data, wherein the time limit is a time when the signal parameter is predicted to reach the limit parameter.

2. The method of claim 1, wherein in step (a) the deriving the signal parameter comprises extracting the signal parameter from the raw electronic signals or from electronic signals processed therefrom, in particular amplified and/or filtered electronic signals; in particular wherein at least one of the raw electronic signals is obtained as an average over a plurality of measurements, or at least one of the raw electronic signals is obtained by signal processing in the processing unit.

3. The method of claim 1, wherein the ultrasonic signals are emitted by a first ultrasonic transducer and/or by a second ultrasonic transducer, and wherein the ultrasonic signals are reflected at least once before being measured by the ultrasonic transducer(s).

4. The method of claim 3, wherein the ultrasonic signals are transferred via at least two different reflection paths, and the method elements (a)-(d) are performed separately for each of the reflection paths.

5. (canceled)

6. The method of claim 1, wherein the signal parameter is an amplitude of the raw electronic signal.

7. The method of claim 1, comprising the step of amplifying the raw electronic signals by applying a gain factor to produce amplified electronic signals as a function of time, wherein the gain factor is adapted to provide an amplification of the raw electronic signals such that the amplified electronic signals exceed a given minimum threshold value, and wherein the signal parameter is or corresponds to the gain factor and the limit parameter is or corresponds to a gain factor limit.

8. The method of claim 1, wherein the ultrasonic sensor comprises a signal processing unit configured to process the raw electronic signals and/or to amplify the raw electronic signals by applying the gain factor to produce the amplified electronic signals as a function of time, in particular wherein the ultrasonic sensor is an ultrasonic sensor for measuring a flow and/or temperature of a fluid through a channel.

9. The method of claim 1, wherein the limit parameter is determined such that a required minimum signal to noise ratio of the raw electronic signals is not underrun; and/or wherein the gain factor limit is determined such that a required minimum signal to noise ratio of the amplified electronic signal is not underrun.

10. The method of claim 1, further comprising in step (b) a step of selecting an initial signal parameter corresponding to a specified or a predetermined value of the raw electronic signal; and/or comprising in step (b) a step of selecting an initial gain factor corresponding to a specified or a predetermined value of the amplified electronic signal.

11. The method of claim 10, wherein the initial signal parameter and/or the initial gain factor is determined during a calibration or start-up procedure; and/or the set of data comprises at least two data pairs.

12. The method of claim 1, the method further comprising a step of creating a signal parameter time curve using the set of data.

13. The method of claim 12, wherein the signal parameter time curve is obtained by a step of interpolating the set of data.

14. The method of claim 12, comprising a step of extrapolating the signal parameter time curve and determining the time limit from an intersection between the extrapolated signal parameter time curve and a limit parameter threshold value.

15. The method of claim 14, wherein the extrapolation is based on a subset of the set of data.

16. The method of claim 15, wherein the extrapolation is performed on a part of the signal parameter time curve bounded by a lower calculation limit and an upper calculation limit of the signal parameter.

17. The method of any one of the claim 13, wherein the step of interpolating is performed repeatedly or stepwise, when the signal parameter reaches a subsequent lower or a subsequent upper calculation limit.

18. The method of claim 16, wherein a series of calculation limits is selected such that a distance between subsequent calculation limits is monotonously decreasing, in particular when approaching the limit parameter and/or an alarm threshold.

19. The method of claim 12, wherein the signal parameter time curve is linear or stepwise linear.

20. The method of claim 1, wherein measurement time intervals are selected in a range from one month to several years.

21. (canceled)

22. The method of claim 1, the method further comprising a step of raising an alarm when the signal parameter reaches the limit parameter.

23. The method of claim 1, the method further comprising the step of setting an alarm threshold for the signal parameter smaller or larger than the limit parameter and raising an alarm when the signal parameter reaches the alarm threshold.

24. The method of claim 1, wherein the limit parameter and/or the alarm threshold is determined such that a threshold amplitude of the raw electronic signals, which is indicative of a maximal allowable dirt accumulation in the system for ventilation, is not underrun; and/or wherein the gain factor limit and/or the alarm threshold is determined such that a threshold amplitude of the amplified electronic signals, which is indicative of a maximal allowable dirt accumulation in the system of ventilation, is not underrun.

25. The method of claim 24, wherein the maximal allowable dirt accumulation in the system of ventilation is chosen according to hygenic requirements, and the limit parameter is a hygenic limit parameter and/or the alarm threshold is a hygenic alarm threshold.

26. The method of claim 24, wherein the maximal allowable dirt accumulation in the system of ventilation is chosen according to fire safety requirements, and the limit parameter is a fire safety limit parameter and/or the alarm threshold is a fire safety alarm threshold.

27. (canceled)

28. The method of claim 1, wherein the method serves for detecting malfunctioning of the ultrasonic sensor, in particular signal fading due to accumulation of dust or debris on the ultrasonic transducer and/or on at least one reflection point or reflection surface of the conduit.

29. The method of claim 1, wherein the ultrasonic signals from the ultrasonic transducers providing reduced raw sensor signals or requiring increased gain factors compared to other ultrasonic transducers are used with less weight or are neglected, e.g. when determining the flow and/or temperature of the fluid through the channel.

30. The method of claim 1, wherein the ultrasonic sensor comprises at least two ultrasonic transducers that are fixed to a channel section and are arranged at a distance from each other along the channel section, in particular wherein the channel section comprises at least one reflector for providing a reflection path for one or between two of the ultrasonic transducers.

31. A sensor comprising:
an ultrasonic transducer configured to measure ultrasonic signals as a function of time and to produce a raw electronic signals as a function of time; and
a signal processing unit configured to process the raw electronic signals and/or to amplify the electronic signals by applying a gain factor to produce amplified electronic signals as a function of time,
wherein the sensor is configured to perform the method for predictive maintenance of claim 1.

32. A non-transitory computer readable medium storing instructions which, when is executed by a computer, cause the computer to carry out the steps of the method of claim 1.

33. The method of claim 13, wherein the interpolation is linear or stepwise linear.

34. The method of claim 14, wherein the extrapolation is linear or stepwise linear.
